(19) United States
(12) Patent Application Publication
(10) Pub. No.: US 2010/0141023 A1
(43) Pub. Date: Jun. 10, 2010

(54) WHEEL RIM

(75) Inventor: Tzu-Sing THO, Taichung City (TW)

Correspondence Address: BRIAN M. MCINNIS, 12th Floor, Ruttonjee House, 11 Duddell Street, Hong Kong, HK

(73) Assignee: Tzu-Sing THO, Taichung City (TW)

(21) Appl. No.: 12/422,968

(22) Filed: Apr. 13, 2009

(30) Foreign Application Priority Data
Dec. 4, 2008 (TW) 97147153

(51) Int. Cl. B60B 21/02

(52) U.S. Cl. 301/95.104

(57) ABSTRACT

A wheel rim includes a V-shaped tube, at least two hook walls and at least two hooks. The V-shaped tube includes at least two sidewalls and a bearing portion. The sidewalls are disposed opposite each other. The bearing portion connects the sidewalls. The hook walls are linearly connected to the sidewalls of the V-shaped tube respectively, wherein each of the sidewalls of the V-shaped tube includes a first end connected to the bearing portion and a second end connected to one of the hook walls. The hooks are connected to the hook walls respectively.

### RELATED APPLICATIONS

The application claims priority to Taiwan Application Serial Number 97147153, filed Dec. 4, 2008, which is herein incorporated by reference.

### BACKGROUND

1. Field of Invention

The present invention relates to land vehicles. More particularly, the present invention relates to a rim.

2. Description of Related Art

Recently, with the prevalence of environmental protection and recreational activities, biking has become more popular. Cycle racing has become a more important part in the extreme sport.

In order to save the biker's stamina and increase the speed, the wheel rim for racing bikes has a diameter longer than that of ordinary bike. However, the longer the diameter of the wheel rim, the heavier the weight of the racing bike. That will increase the burden of the biker.

FIG. 1 is a part of cross-section view of a wheel rim according to a prior art. The wheel rim includes a tube 100 and two walls 110. The tube 100 includes two sidewalls 101. The sidewalls 101 are connected to the walls 110. When the wheel rim is applied to a racing bike, the walls 110 are pressed upon the ground. The action a acts along the walls 110 and the reaction b acts along the side walls 101. Because the sidewalls 101 are not linearly connected to the walls 110, the part between the sidewall 101 and the walls 110 is easily bent.

### SUMMARY

According to one embodiment of the present invention, a wheel rim includes a V-shaped tube, at least two hook walls and at least two hooks. The V-shaped tube includes at least two sidewalls and a bearing portion. The sidewalls are disposed opposite each other. The bearing portion connects the sidewalls. The hook walls are linearly connected to the sidewalls of the V-shaped tube respectively. Each of the sidewalls of the V-shaped tube includes a first end connected to the bearing portion and a second end connected to one of the hook walls, and the thickness of the first end is less than the thickness of the second end. The hooks are connected to the hook walls respectively.

### BRIEF DESCRIPTION OF THE DRAWINGS

The invention can be more fully understood by reading the following detailed description of the embodiment, with reference made to the accompanying drawings as follows:

FIG. 1 is part of cross-section of a wheel rim according to a prior art.

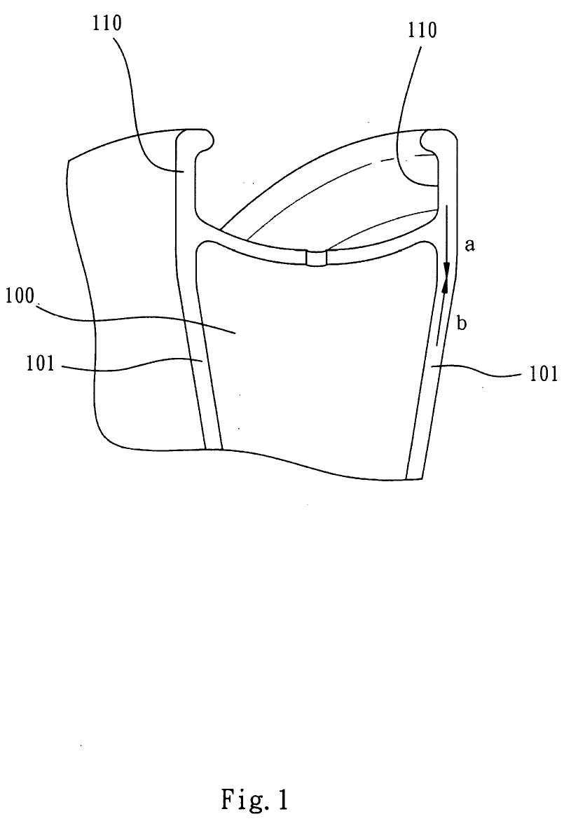

FIG. 2 is a cross-section of a wheel rim according to one embodiment of this invention.

FIG. 3 is a cross-section of the wheel rim of FIG. 1 in operation.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

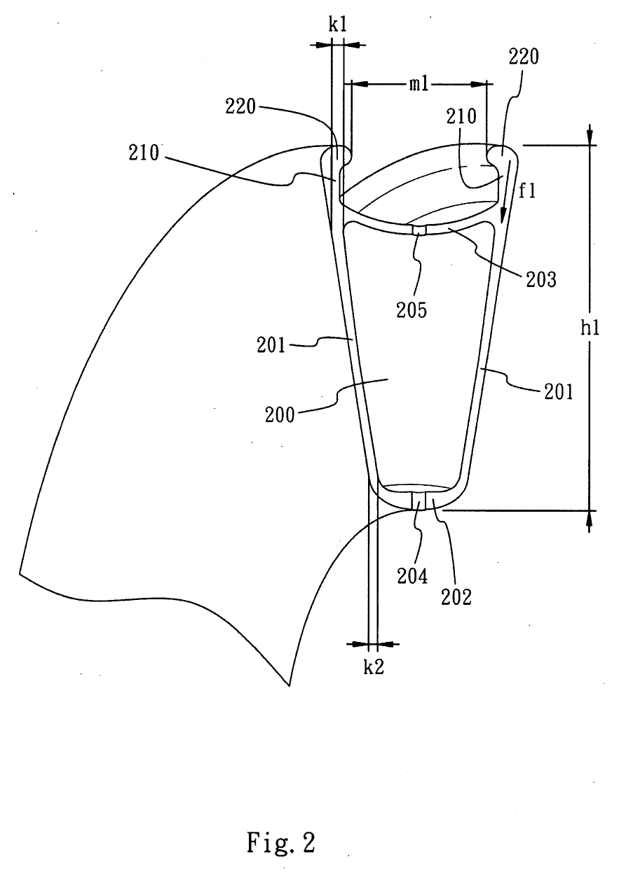

Referring to FIG. 2, a wheel rim includes a V-shaped tube 200, two hook walls 210 and two hooks 220.

The V-shaped tube 200 includes two sidewalls 201, a bearing portion 202, and a supporting portion 203. The sidewalls 201 are disposed opposite each other. The bearing portion 202 is disposed opposite the supporting portion 203. The bearing portion 202 connects the first side of the sidewalls 201. The supporting portion 203 is connected to the second side of the sidewalls 201.

The hook walls 210 are linearly connected to the sidewalls 201 of the V-shaped tube 200 respectively. Each of the sidewalls 201 includes a first end connected to the bearing portion 202 and a second end connected to one of the hook walls 210. When the wheel rim is applied to the racing bike, the hook walls 210 are pressed upon the ground. The direction of the pressure f1 straightly acts on the wheel rim as the hook walls 210 are linearly connected to the sidewalls 201 of the V-shaped tube 200 respectively. Therefore, the part between the sidewalls 201 and the hook walls 210 can't be bent.

The hooks 220 are connected to the hook walls 210 respectively. The vertical height h1 of the combination of the V-shaped tube 200, the hook walls 210, and the hooks 220 are from 37 mm to 50 mm. In this embodiment, the vertical height h1 may be 37 mm. When the wheel rim is applied to a racing bike, the vertical height h1 of the wheel rim is high enough to decrease the turbulent flow. The ratio of the vertical height h1 of the combination of the V-shaped tube 200, the hook walls 210, and the hooks 220 to a distance m₁ between the hooks 220 is 1.5˜2 or greater than 2. In this embodiment, the ratio of h1 to m1 is larger than 2, but the ratio also can be 1.5 or 2. Hence the ratio of h1 to m1 can decrease the turbulent flow effectively.

The thickness of the first end k2 is less than the thickness of the second end k1. The bearing portion 202 can't be deformed as the thickness of the second end k1 is greater than the thickness of the first end k2. The weight of the wheel rim will be lighter than the thickness of the first end k2 is the same as the thickness of the second end k1. It not only decreases the load but also increases the speed when riding.

The V-shaped tube, the hook walls, and the hooks are made up of one piece of aluminum alloy or carbon fibers.

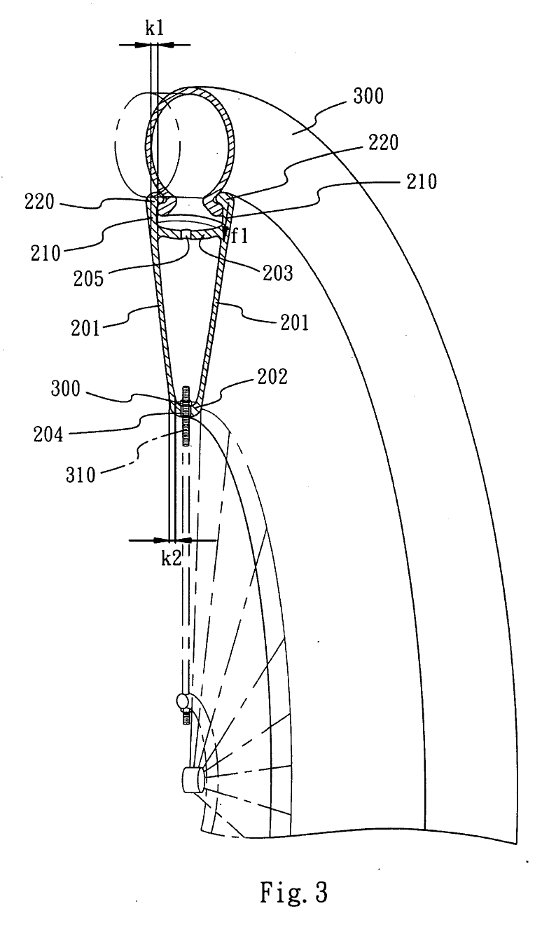

Referring to FIG. 3, a tire 300 is disposed between the hook walls 210. The hooks 220 catch the tire 300. The bearing portion 202 includes a plurality of holes 204 located thereon. The supporting portion 203 includes a plurality of holes 205 located thereon. The holes 204 and the holes 205 allow spokes to pass there through. The wheel rim further includes a plurality of nuts 320 for fastening the spokes 310 to the holes 204 of the bearing portion 202.

What is claimed is:

1. A wheel rim comprising:
a V-shaped tube comprising:
at least two sidewalls disposed opposite each other; and
a bearing portion connecting the sidewalls;
at least two hook walls linearly connected to the sidewalls of the V-shaped tube respectively, wherein each of the sidewalls of the V-shaped tube comprises a first end connected to the bearing portion and a second end connected to one of the hook walls; and
at least two hooks connected to the hook walls respectively.

2. The wheel rim of claim 1, wherein the sidewall thickness of the first end is less than the thickness of the second end.

3. The wheel rim of claim 2, wherein the vertical height of the combination of the V-shaped tube, the hook walls, and the hooks is from 37 mm to 50 mm.

4. The wheel rim of claim 2, wherein the vertical height of the combination of the V-shaped tube, the hook walls, and the hooks is 37 mm.

5. The wheel rim of claim 2, wherein the V-shaped tube comprises:
at least one supporting portion connecting the sidewalls and disposed opposite the bearing portion, wherein the supporting portion comprises a plurality of holes located thereon for allowing spokes to pass there through.

6. The wheel rim of claim 5, wherein the bearing portion comprises a plurality of holes located thereon for allowing the spokes to pass there through.

7. The wheel rim of claim 6, further comprising:
a plurality of nuts fastening the spokes to the holes of the bearing portion.

8. The wheel rim of claim 2, wherein the V-shaped tube, the hook walls, and the hooks are made up of one piece of aluminum alloy.

9. The wheel rim of claim 2, wherein the V-shaped tube, the hook walls, and the hooks are made of carbon fibers.

10. The wheel rim of claim 2, wherein the ratio of the vertical height of the combination of the V-shaped tube, the hook walls, and the hooks to a distance between the hooks is greater than 2.

11. The wheel rim of claim 2, wherein the ratio of the vertical height of the combination of the V-shaped tube, the hook walls, and the hooks to a distance between the hooks is 1.5˜2.
